(19) United States
(12) Patent Application Publication
(10) Pub. No.: US 2008/0072779 A1
(43) Pub. Date: Mar. 27, 2008

(54) PROTECTING/PACKAGING MATERIAL FOR LITHOGRAPHIC PRINTING PLATE AND METHOD FOR PACKAGING LITHOGRAPHIC PRINTING PLATE

(75) Inventors: Yasuhiro ANNOURA, Haibara-gun (JP); Tomoyoshi MITSUMOTO, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/860,753

(22) Filed: Sep. 25, 2007

(30) Foreign Application Priority Data
Sep. 25, 2006 (JP) 2006-259657

(51) Int. Cl. B41N 3/00

(52) U.S. Cl. 101/463.1

(57) ABSTRACT

It is an object of the present invention to provide a protecting/packaging material for a lithographic printing plate capable of preventing the toning of the lithographic printing plate and a method for packaging the lithographic printing plate. In a protecting/packaging material for protecting and/or packaging a lithographic printing plate, a chlorine concentration contained in a inter leaf, protective pasteboard or package paper for the lithographic printing plate used with the lithographic printing plate brought into contact with a photosensitive layer of the lithographic printing plate is set to 1.5% by weight or less.

### BACKGROUND OF THE INVENTION

1. Field of the Invention

The present invention relates to a protecting/packaging material for a lithographic printing plate and a method for packaging the lithographic printing plate. Particularly, the present invention relates to the improvement in toning of the lithographic printing plate caused by the protecting/packaging material.

2. Description of the Related Art

A lithographic printing plate generally has oleophilic image areas which receive an ink during printing and hydrophilic nonimage areas which receive a fountain solution. Lithographic printing is a printing process in which the surface of a lithographic printing plate is made to have a difference in ink adhesion by forming oleophilic image areas as ink-receiving areas and hydrophilic nonimage areas as fountain-solution-receiving areas (non-ink-receiving areas) based on the fact that water has the property of repelling oil-based inks, and an ink is adhered only to the image areas and then transferred to a material to be printed, such as paper.

The conventional platemaking processes for the lithographic printing original plate necessitate a step in which unnecessary parts of the image-recording layer after exposure are dissolved and removed with a developing solution or the like. However, to eliminate or simplify such a wet treatment performed additionally is one of the problems to be accomplished. In particular, the discard of waste liquids resulting from wet treatments has recently become a matter of considerable concern of the whole industrial world from the standpoint of care of the global environment and, hence, there is an increasingly growing desire for the accomplishment of the problem.

On the other hand, digitization technology in which image information is electronically processed, accumulated, and outputted by a computer has recently come to spread extensively, and various new image output techniques suitable for such digitization technology have come to be practically used. That is, attention has been focused on a computer-to-plate technique in which a highly convergent radiation such as a laser light is caused to carry digitized image information and this light is used to scan and expose a lithographic printing original plate to directly produce a lithographic printing plate without via a lith film.

For example, there has been known a lithographic printing plate comprising a hydrophilic support and, formed thereon, an image-forming layer comprising a hydrophilic binder and hydrophobic thermoplastic-polymer particles dispersed therein as the lithographic printing plate of such a computer-to-plate (for example, see Japanese Patent No. 2938397). This lithographic printing original plate can be used in the following manner. The lithographic printing original plate is exposed with an infrared laser to thermally bond the hydrophobic thermoplastic-resin particles to one another and thereby form an image. Thereafter, this lithographic printing original plate is attached to the cylinder of a printing machine and developed thereon with a fountain solution and/or an ink (hereinafter, referred to as “lithographic printing plate for on-press development”).

A strip of raw material of the conventional lithographic printing plate and lithographic printing plate for on-press development is cut to product size in a processing process, and the cut materials are then packaged for shipment.

The lithographic printing plates are generally packaged by the following method. A stacked bundle of one unit is prepared by stacking several to tens of the lithographic printing plates, and this stacked bundle is packaged. In this case, the stacked lithographic printing plates may rub mutually to damage photosensitive layers. Also, when the raw material of the lithographic printing plate is cut in a product size by a cutter, metal is adhered to an edge in only the lithographic printing plate (that is, when using no inter leaf to be described later) using metal as the support. The cut surface of the lithographic printing plate is not in a specular surface state, and is in a bumpy notched state.

Then, in order to protect the photosensitive layer from the friction damage of a cut edge and the cut damage in cutting, and to suppress the damage of the cut edge itself to increase the number of times of cutting, a thin sheet referred to as inter leaf is inserted between the stacked lithographic printing plates. Not only the enhancement of the protection and cutting property of the photosensitive layer but also easy peeling property in supplying the lithographic printing plate to an image forming device such as a setter are required for this inter leaf.

Conventional examples of the inter leafs for attaining the above object include one prepared by making paper contain wax (Japanese Examined Application Publication No. 61-19025), one prepared by making paper contain a fatty acid or a salt thereof (Japanese Patent Application Laid-Open No. 55-118041), and one prepared by making paper contain polyolefin pulp and an alkali metal halide (Japanese Patent Application Laid-Open No. 57-99647).

In the packaging process of the lithographic printing plate, not only the above inter leaf but also the protective pasteboard (commonly known as padding cardboard), the package paper or the like are used. That is, while several to tens of the lithographic printing plates are stacked, a protective pasteboard is provided on the upper surface and lower surface of a stacked bundle prepared by inserting inter leafs between the lithographic printing plates. In this state, the stacked bundle is packaged by the package paper.

### SUMMARY OF THE INVENTION

However, the lithographic printing plate packaged by the conventional protecting/packaging material protecting and/or packaging the lithographic printing plate has had a problem that “toning” caused by the ink of the nonimage areas is generated. Particularly, the toning was notably generated in the lithographic printing plate having the photosensitive layer for on-press development.

The present inventor has conducted earnest studies of the cause of the toning based on the fact, and has found that a protecting material (for example, a inter leaf, a protective pasteboard or the like) or a packaging material used in contact with the photosensitive layer of the lithographic printing plate, are a main cause.

The present invention has been accomplished in view of the problems described above. It is an object of the present invention to provide a protecting/packaging material for a lithographic printing plate capable of preventing the toning of the lithographic printing plate. It is another object of the present invention to provide a method for packaging the lithographic printing plate.

The above objects are accomplished, in accordance with a first aspect of the present invention, by the provision of a protecting/packaging material for protecting and/or packaging a lithographic printing plate, which serves in contact with a photosensitive layer of the lithographic printing plate, wherein the protecting/packaging material has a chlorine concentration of 1.5% by weight or less.

The present inventor found that chlorine contained in a protecting material and a packaging material (hereinafter, referred to as “protecting/packaging material”) causes toning and a chlorine concentration exceeding 1.5% by weight causes the toning.

In accordance with the first aspect, the toning caused by the protecting/packaging material can be prevented by protecting or packaging the lithographic printing plate using the protecting/packaging material having a chlorine concentration of 1.5% by weight or less. Although the protecting material and packaging material prepared by coating plastic on paper or a paper base are generally used, the present invention includes the other protecting material and packaging material.

In accordance with a second aspect of the present invention, there is provided a protecting/packaging material for protecting and/or packaging a lithographic printing plate as set forth in the first aspect of the present invention, wherein the protecting/packaging material has a chlorine concentration of 0.47% by weight or less.

The protecting/packaging material having a chlorine concentration of 0.47% by weight or less can prevent the toning more surely.

In accordance with a third aspect of the present invention, there is provided a protecting/packaging material for protecting and/or packaging a lithographic printing plate as set forth in the first or second aspect of the present invention, wherein the protecting/packaging material is a inter leaf inserted between the lithographic printing plates when the lithographic printing plates are stacked.

The inter leaf prevents the damage of a photosensitive layer caused by friction of the lithographic printing plates in stacking the lithographic printing plates. Since it is particularly preferable that the inter leaf has a large area in contact with the photosensitive layer, the chlorine concentration of the inter leaf is set to 1.5% by weight or less for preventing the toning.

In accordance with a fourth aspect of the present invention, there is provided a protecting/packaging material for protecting and/or packaging a lithographic printing plate as set forth in the first or second aspect of the present invention, wherein the protecting/packaging material is package paper for packaging the lithographic printing plate or a stacked bundle of the lithographic printing plates.

Since the packaging material may be brought into contact with the photosensitive layer when the packaging material packages the lithographic printing plate or the stacked bundle, it is preferable to set the chlorine concentration to 1.5% by weight or less. Since the inter leaf is not used when the packaging material packages one lithographic printing plate particularly, the package paper is directly brought into contact with the lithographic printing plate.

In accordance with a fifth aspect of the present invention, there is provided a protecting/packaging material for protecting and/or packaging a lithographic printing plate as set forth in the first or second aspect of the present invention, wherein the protecting/packaging material is a protective pasteboard applied to an upper surface and lower surface of the lithographic printing plate or stacked bundle of the lithographic printing plates when the protecting/packaging material packages the lithographic printing plate.

Since the photosensitive layer is exposed in any of the upper surface and lower surface of the stacked bundle to directly bring the protective pasteboard into contact with the photosensitive layer, it is preferable to set the chlorine concentration of the protective pasteboard to 1.5% by weight or less.

In accordance with a sixth aspect of the present invention, there is provided a protecting/packaging material for protecting and/or packaging a lithographic printing plate as set forth in any one of the first to fifth aspects of the present invention, wherein the lithographic printing plate includes a photosensitive layer for on-press development.

As described above, since the toning of the lithographic printing plate is particularly and easily exhibited on the lithographic printing plate including the photosensitive layer for on-press development, the protecting/packaging material of the present invention is particularly effective. The toning is considered to be easily exhibited on the lithographic printing plate including the photosensitive layer for on-press development since a polymerization initiator contained as the ingredient of the photosensitive layer is decomposed by chlorine contained in the protecting/packaging material.

The above objects are accomplished, in accordance with a seventh aspect of the present invention, by the provision of a method for packaging a lithographic printing plate, comprising the step of packaging the lithographic printing plate using a packaging material having a chlorine concentration of 1.5% by weight or less.

Since the method of the seventh aspect includes the step of packaging the lithographic printing plate using the packaging material having a chlorine concentration of 1.5% by weight or less, the toning of the lithographic printing plate can be prevented.

In accordance with an eighth aspect of the present invention, there is provided a method for packaging a lithographic printing plate as set forth in the seventh aspect of the present invention, further comprising, prior to packaging the lithographic printing plate using the packaging material, at least one of the steps of: stacking the plurality of lithographic printing plates to produce a stacked bundle and inserting a inter leaf having a chlorine concentration of 1.5% by weight or less between the stacked lithographic printing plates; and applying a protective pasteboard having a chlorine concentration of 1.5% by weight or less to the upper surface and/or lower surface of the stacked bundle.

Since, in the process for packaging the lithographic printing plate, the stacked bundle prepared by stacking the lithographic printing plates is often packaged as one unit. In this case, a step for inserting the inter leaf between the lithographic printing plates and a step for providing the protective pasteboard on the upper surface and/or lower surface of the stacked bundle are often performed, and thus it is preferable that the chlorine concentration of the inter leaf or protective pasteboard is 1.5% by weight or less.

In accordance with a ninth aspect of the present invention, there is provided a lithographic printing plate or a stack thereof protected and/or packaged by the protecting/packaging material of the first or second aspect.

Thereby, the toning caused by the protecting/packaging material for the lithographic printing plate or a stack thereof can be prevented.

According to the protecting/packaging material for the lithographic printing plate of the present invention and the method for packaging the lithographic printing plate, the toning of the lithographic printing plate caused by the protecting/packaging material can be prevented. The present invention is particularly effective for preventing the toning of the lithographic printing plate having the photosensitive layer for on-press development.

### BRIEF DESCRIPTION OF THE DRAWINGS

FIG. 1 is an illustration of a first process of a method for packaging a lithographic printing plate;

FIG. 2 is an illustration of a second process of a method for packaging a lithographic printing plate;

FIG. 3 is an illustration of a third process of a method for packaging a lithographic printing plate;

FIG. 4 is an illustration of a fourth process of a method for packaging a lithographic printing plate;

FIG. 5 is an illustration for packaging a packaging body packaged in the first to fourth processes using a package box; and

FIG. 6 is a development view of a package box.

### DETAILED DESCRIPTION OF THE PREFERRED EMBODIMENTS

Hereinafter, with reference to the drawings, the preferred embodiment of a protecting/packaging material for a lithographic printing plate and method for packaging the lithographic printing plate of the present invention will be described in full detail.

First, the lithographic printing plate which easily exhibits toning and has a photosensitive layer for on-press development will be described.

### (Lithographic Printing Plate for on-Press Development)

On-press development is a platemaking method using an image-recording layer allowing unnecessary parts to be removed on a lithographic printing plate during the ordinary printing process, and after exposure, removing nonimage areas thereof on a printing machine to develop the lithographic printing plate. For example, there has been known a lithographic printing original plate comprising a hydrophilic support and, formed thereon, an image-forming layer comprising a hydrophilic binder and hydrophobic thermoplastic-polymer particles dispersed therein.

The technique described above in which an image is formed by the mere bonding of polymer fine particles by thermal fusion attains satisfactory on-press developability. However, this technique has had a problem that image strength (adhesion to the support) is considerably low and run length is insufficient. There has been proposed a lithographic printing original plate which improves the run length of the lithographic printing original plate capable of on-press development (for example, Japanese Patent Application Laid-Open Nos. 2001-277740 and 2001-277742). The lithographic printing original plate includes a hydrophilic support, and a thermal layer provided on the hydrophilic support, the thermal layer containing microcapsules containing a compound having a functional group reacted by heat. An infrared absorber is contained in the thermal layer or a layer adjacent thereto.

There has been known a lithographic printing original plate capable of on-press development comprising a support which is typically an aluminum plate, and formed thereon, a photosensitive layer comprising an infrared absorber, a radical polymerization initiator and a polymerizable compound as another technique which improves the run length (for example, Japanese Patent Application Laid-Open No. 2002-287334). Furthermore, the following lithographic printing original plate has been described in Japanese Patent Application Laid-Open No. 2000-39711. The lithographic printing original plate includes an aluminum support and formed thereon, a photosensitive layer comprising a photosensitive composition containing (a) a water-soluble or water-dispersible polymer, (b) a monomer or oligomer having a photopolymerizable ethylenically unsaturated double bond, and (c) a photopolymerization initiation system having absorption maximum in an ultraviolet range, and is capable of on-press development after exposure.

The techniques utilizing a polymerization reaction can enhance image strength since the image areas have a higher chemical-bond density than the image areas formed by the thermal fusion bonding of fine polymer particles. However, the techniques were still insufficient in view of coexistence of the on-press developability and thin line reproducibility or run length.

On the other hand, in the lithographic printing plate for on-press development, an overcoat layer (protective layer) is usually provided on the image-recording layer for the purposes of preventing the image-recording layer from suffering mars, shutting off oxygen, and preventing ablation in high-illuminance laser exposure. Herein, although a water-soluble high polymer compound having excellent crystallinity such as polyvinyl alcohol has been used for the overcoat layer as the main component, the further improvement of on-press developability, thin line reproducibility, run length and on-press developing running property (aptitudes such as the mixing of on-press developing removed object to fountain solution and the deposition of the removed object onto a platen in continuously repeating on-press development and printing) has been desired.

On the other hand, in Japanese Patent Application Laid-Open No. 11-38633, an overcoat layer contains an inorganic layer compound, and thereby the high sensitivity and storage stability of a photosensitive material are attained. However, a negative image recording material due to alkali development is disclosed in this patent, and is different from an on-press developing plate material.

From such a background, the present inventor has proposed a lithographic printing plate for on-press development provided with the following constitution as the lithographic printing plate having excellent on-press developability, thin line reproducibility, run length and on-press developing running property.

(1) A lithographic printing plate comprising a support, an image-recording layer which contains (a) an actinic ray absorber, (b) a polymerization initiator and (c) a polymerizable compound and can be removed by an printing ink, a fountain solution or both the printing ink and the fountain solution, and an overcoat layer containing an inorganic layer compound in this order.

(2) A lithographic printing plate comprising a support, an undercoat layer containing a compound having a polymerizable group, an image-recording layer which contains (a) an actinic ray absorber, (b) a polymerization initiator and (c) a polymerizable compound and can be removed by an printing ink, a fountain solution or both the printing ink and the fountain solution, and an overcoat layer containing an inorganic layer compound in this order.

(3) A lithographic printing plate wherein (a) the actinic ray absorber is an infrared absorber.

(4) A lithographic printing plate wherein the inorganic layer compound contained in the overcoat layer is a swelling inorganic layer compound.

Examples of the polymerization initiators used for the lithographic printing plates of the above items (1) to (4) include organic halogen compounds, carbonyl compounds, organic peroxides, azo polymerization initiators, azide compounds, metallocene compounds, hexaarylbiimidazole compounds, organoboron compounds, disulfone compounds, oxime ester compounds, oxime ether compounds, and onium salt compounds.

It is preferable that the polymerization initiator has an absorption maximum wavelength of 400 nm or less. It is more preferable that the polymerization initiator has an absorption maximum wavelength of 360 nm or less. It is most preferable that the polymerization initiator has an absorption maximum wavelength of 300 nm or less. Thus, the safety under white light of the lithographic printing original plate is enhanced by setting the absorption wavelength to the ultraviolet range.

These polymerization initiators can be added in an amount of 0.1 to 50% by mass, preferably 0.5 to 30% by mass, particularly preferably 1 to 20% by mass, based on all solid ingredients constituting the image-recording layer. When the initiator amount is within this range, satisfactory sensitivity is obtained and the nonimage areas have satisfactory insusceptibility to toning during printing. These polymerization initiators may be used alone or in combination of two or more thereof. Any of these polymerization initiators and the other ingredients may be added to the same layer. Alternatively, a layer containing any of the polymerization initiators may be separately formed.

Specific examples of the organic halogen compounds include the compounds described in Wakabayashi, et al., “Bull. Chem. Soc. Japan” 42, 2924 (1969), the specification of U.S. Pat. No. 3,905,815, Japanese Examined Application Publication No. 46-4605, Japanese Patent Application Laid-Open Nos. 48-36281, 53-133428, 55-32070, 60-239736, 61-169835, 61-169837, 62-58241, 62-212401, 63-70243 and 63-298339, and M. P. Hutt, “Journal of Heterocyclic Chemistry” 1 (No. 3) (1970). Among these, oxazole and S-triazine compounds with substituted trihalomethyl group are preferred. More preferable examples include s-triazine derivatives in which at least one mono-, di- or trihalogen-substituted methyl group is attached to an s-triazine ring, such as 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-i-propyl oxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2-[4-(p-hydroxybenzoylamino)phenyl]-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine.

Examples of the carbonyl compounds include benzophenone derivatives such as benzophenone, Michler's ketone, 2-methylbenzophenone, 3-methylbenzophenone, 4-methylbenzophenone, 2-chlorobenzophenone, 4-bromobenzophenone, and 2-carboxybenzophenone; acetophenone derivatives such as 2,2-dimethoxy-2-phenylacetophenone, 2,2-diethoxyacetophenone, 1-hydroxycyclohexylphenyl ketone, α-hydroxy-2-methylphenyl propanone, 1-hydroxy-1-methylethyl-(p-isopropylphenyl) ketone, 1-hydroxy-1-(p-dodecylphenyl)ketone, 2-methyl-(4′-(methylthio)phenyl)-2-morpholino-1-propanone, 1,1,1-trichloromethyl-(p-butylphenyl)ketone; thioxantone derivatives such as thioxantone, 2-ethyl thioxantone, 2-isopropyl thioxantone, 2-chlorothioxantone, 2,4-dimethyl thioxantone, 2,4-diethyl thioxantone, and 2,4-diisopropyl thioxantone; and benzoic acid ester derivatives such as ethyl p-dimethylaminobenzoic acid, and ethyl p-diethylaminobenzoic acid.

As the azo compounds, for example, the azo compounds or the like described in Japanese Patent Application Laid-Open No. 8-108621 can be used.

Examples of the organic peroxides include trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, peroxysuccinic acid, benzoyl peroxide, 2,4-dichlorobenzoyl peroxide, diisopropyl peroxydicarbonate, di-2-ethylhexyl peroxydicarbonate, di-2-ethoxyethyl peroxydicarbonate, dimethoxyisopropyl peroxycarbonate, di(3-methyl-3-methoxybutyl)peroxydicarbonate, tert-butyl peroxyacetate, tert-butyl peroxypivalate, tert-butyl peroxyneodecanoate, tert-butyl peroxyoctanoate, tert-butyl peroxylaurate, tosyl carbonate, 3,3′,4,4′-tetra-(t-butyl peroxycarbonyl)benzophenone, 3,3′,4,4′-tetra-(t-hexyl peroxycarbonyl)benzophenone, 3,3′,4,4′-tetra-(p-isopropylcumyl peroxycarbonyl)benzophenone, carbonyl di(t-butylperoxy dihydrogen diphthalate), and carbonyl di(t-hexylperoxy dihydrogen diphthalate).

Examples of the metallocene compounds include various titanocene compounds as described in Japanese Patent Application Laid-Open Nos. 59-152396, 61-151197, 63-41484, 2-249, 2-4705 and 5-83588, such as di-cyclopentadienyl-Ti-bis-phenyl, di-cyclopentadienyl-Ti-bis-2,6-di-fluorophen-1-yl, di-cyclopentadienyl-Ti-bis-2,4-di-fluorophen-1-yl, di-cyclopentadienyl-Ti-bis-2,4,6-trifluoropheny-1-yl, di-cyclopentadienyl-Ti-bis-2,3,5,6-tetrafluorophen-1-yl, di-cyclopentadienyl-Ti-bis-2,3,4,5,6-pentafluorophen-1-yl, di-methylcyclopentadienyl-Ti-bis-2,6-di-fluorophen-1-yl, di-methylcyclopentadienyl-Ti-bis-2,4,6-trifluorophen-1-yl, di-methylcyclopentadienyl-Ti-bis-2,3,5,6-tetrafluorophen-1-yl, di-methylcyclopentadienyl-Ti-bis-2,3,4,5,6-pentafluorophen-1-yl, bis(cyclopentadienyl)-bis(2,6-difluoro-3-(pill-1-yl)phenyl)titanium; and iron-arene complexes described in Japanese Patent Application Laid-Open Nos. 1-304453 and 1-152109.

Examples of the hexaaryl biimidazole compounds include various compounds described in Japanese Examined Application Publication No. 6-29285, and the specifications of U.S. Pat. Nos. 3,479,185, 4,311,783 and 4,622,286. Specific examples include 2,2′-bis(o-chlorophenyl)-4,4′,5,5′-tetraphenyl biimidazole, 2,2′-bis(o-bromophenyl)-4,4′,5,5′-tetraphenyl biimidazole, 2,2′-bis(o,p-dichlorophenyl)-4,4′,5,5′-tetraphenyl biimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenyl biimidazole, 2,2′-bis(o-nitrophenyl)-4,4′,5,5′-tetraphenyl biimidazole, 2,2′-bis(o-methylphenyl)-4,4′,5,5′-tetraphenyl biimidazole, and 2,2′-bis(o-trifluorophenyl)-4,4′,5,5′-tetraphenyl biimidazole.

Examples of the organic boron compounds include organic boric acid salts as described in Japanese Patent Application Laid-Open Nos. 62-143044, 62-150242, 9-188685, 9-188686, 9-188710, 2000-131837 and 2002-107916, the specification of Japanese Patent No. 2764769, Japanese Patent Application Laid-Open No. 2002-116539 and Kunz, Martin, “Rad Tech'98. Proceeding Apr. 19-22, 1998, Chicago”; organic boron-sulfonium complexes or organic boron-oxosulfonium complexes as described in Japanese Patent Application Laid-Open Nos. 6-157623, 6-175564 and 6-175561; organic boron-iodonium complexes as described in Japanese Patent Application Laid-Open Nos. 6-175554 and 6-175553; organic boron-phosphonium complexes as described in Japanese Patent Application Laid-Open No. 9-188710; and organic boron-transition metal coordination complexes as described in Japanese Patent Application Laid-Open Nos. 6-348011, 7-128785, 7-140589, 7-306527 and 7-292014.

Examples of the disulfone compounds include compounds as described in Japanese Patent Application Laid-Open Nos. 61-166544 and 2003-328465 or the like.

Examples of the oxime ester compounds include compounds described in J. C. S. Perkin II (1979) 1653-1660, J. C. S. Perkin II (1979) 156-162, Journal of Photopolymer Science and Technology (1995) 202-232 and in Japanese Patent Application Laid-Open No. 2000-66385, compounds described in Japanese Patent Application Laid-Open No. 2000-80068. Specific examples include compounds represented by the following structural formulae:

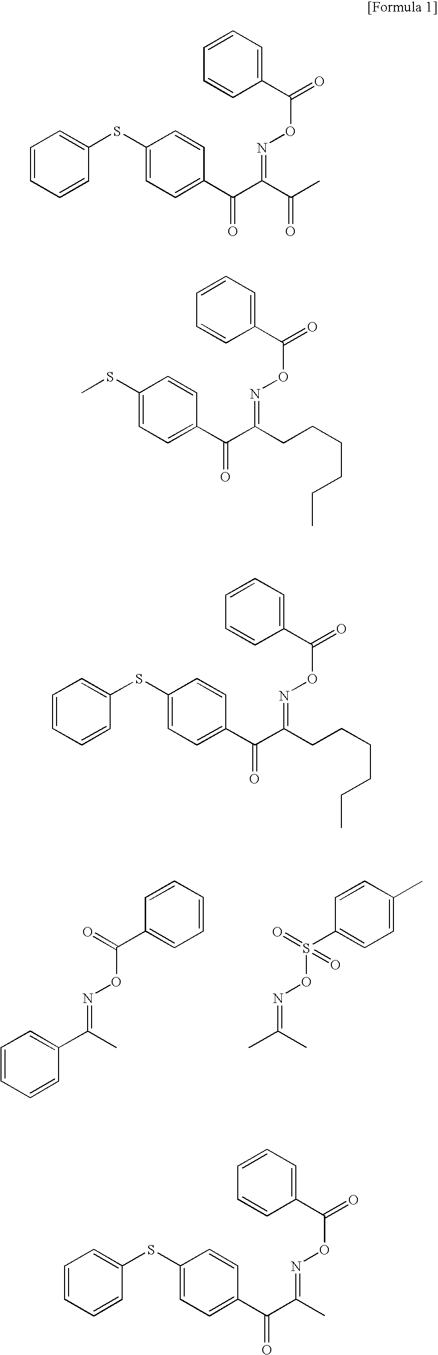

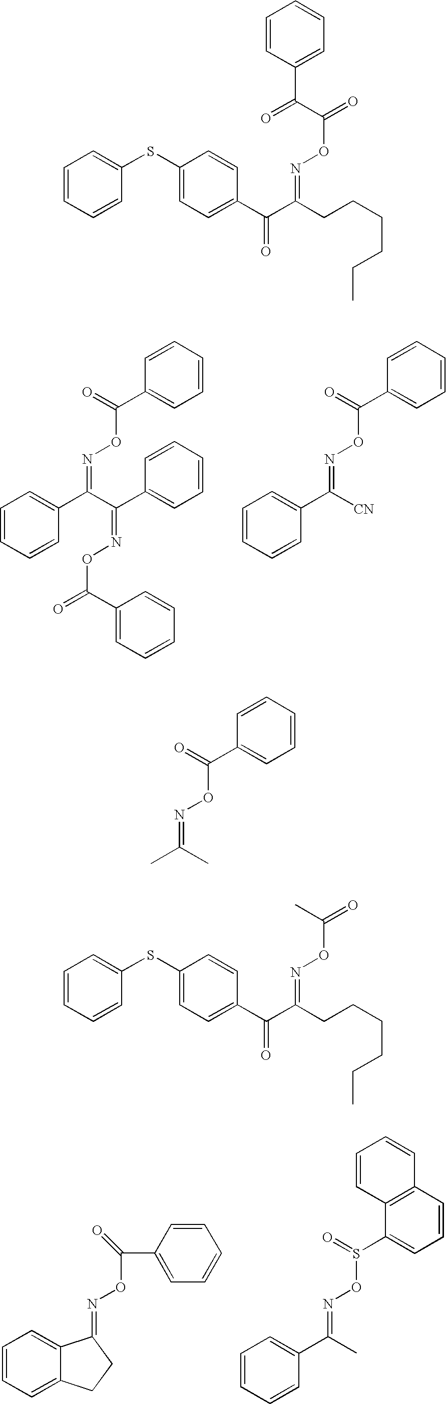

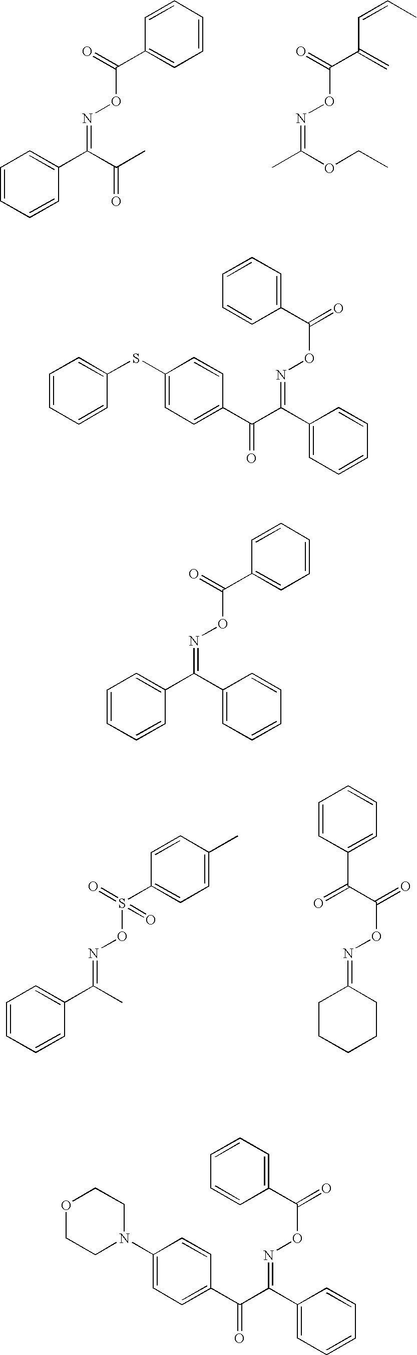

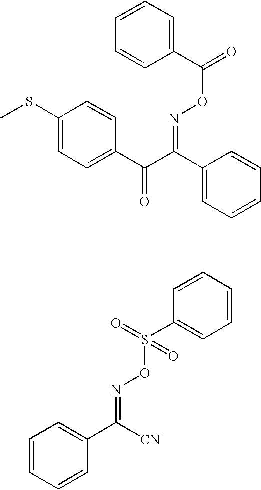

Examples of the oxime ether compounds include compounds described in Japanese Patent Application Laid-Open Nos. 8-202035 and 10-237118. Specific examples include compounds represented by the following structural formulae.

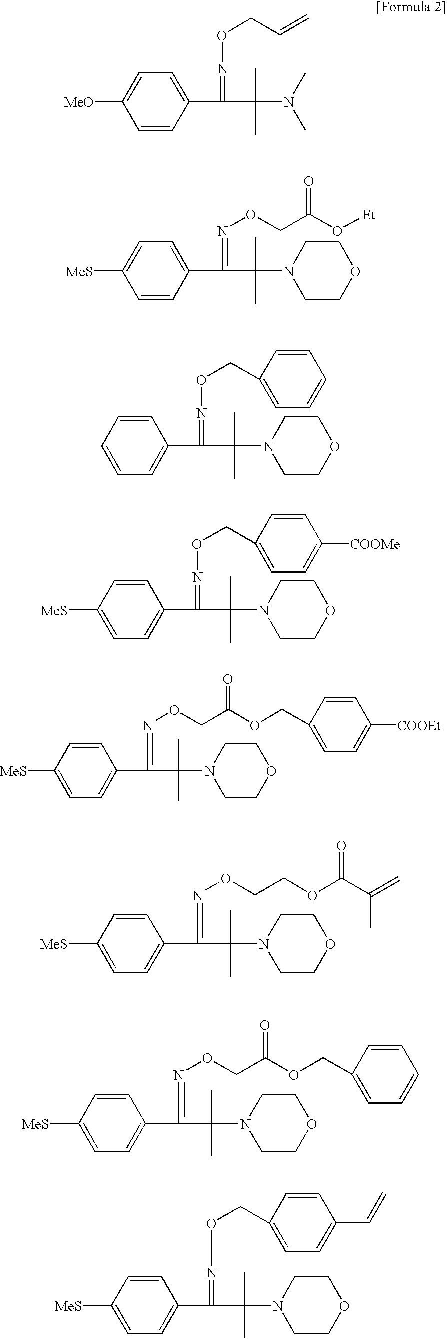

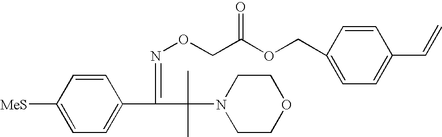

Examples of the onium salt compounds include diazonium salts as described in S. I. Schlesinger, Photogr. Sci. Eng., 18, 387(1974) and T. S. Bal et al., Polymer, 21, 423 (1980); ammonium salts as described in the specification of U.S. Pat. No. 4,069,055, and Japanese Patent Application Laid-Open No. 4-365049 or the like; phosphonium salts as described in the specifications of U.S. Pat. Nos. 4,069,055 and 4,069,056; iodonium salts as described in the specifications of EP No. 104,143, U.S. Pat. Nos. 339,049 and 410,201 and Japanese Patent Application Laid-Open Nos. 2-150848 and 2-296514; sulfonium salts as described in the specifications of EP No. 370,693, 390,214, 233,567, 297,443, 297,442, U.S. Pat. Nos. 4,933,377, 161,811, 410,201, 339,049, 4,760,013, 4,734,444, 2,833,827, DE No. 2,904,626, 3,604,580 and 3,604,581; celenonium salts as described in J. V. Crivello et al., Macromolecules, 10(6), 1307 (1977) and J. V. Crivello et al., J. Polymer Sci., Polymer Chem. Ed., 17, 1047 (1979); and arsonium salts as described in C. S. Wen et al., Teh, Proc. Conf. Rad. Curing ASIA, p 478, Tokyo, October (1988).

Particularly, from the standpoints of reactivity and stability, preferable examples include the oxime ester compounds or onium salts (diazonium salts, iodonium salts, or sulfonium salts) shown above. According to the invention, these onium salts are not acid-generating agents, and they function as ionic radical polymerization initiators. The onium salts suitably used are represented by the following formulae (RI-I) to (RI-III):

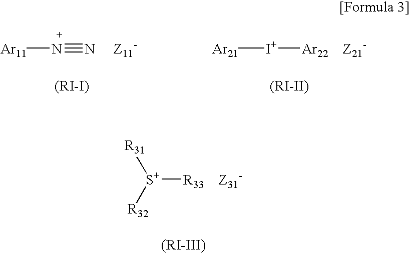

In Formula (RI-I), Ar11 represents an aryl group having up to 20 carbon atoms and optionally having 1 to 6 substituents, wherein preferable substituents include an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkylamido group or arylamido group having 1 to 12 carbon atoms, a carbonyl group, a carboxyl group, a cyano group, a sulfonyl group, a thioalkyl group having 1 to 12 carbon atoms, and a thioaryl group having 1 to 12 carbon atoms. Z11− represents a monovalent anion. Specific examples thereof include a halogen ion, a perchlorate ion, a hexafluorophosphate ion, a tetrafluoroborate ion, a sulfonate ion, a sulfinate ion, a thiosulfonate ion, and a sulfate ion. Among these, preferred are the peroxychlorate ion, hexafluorophosphate ion, tetrafluoroborate ion, sulfonate ion and sulfinate ion in the aspect of stability.

In Formula (RI-II), Ar21 and Ar22 each independently represent an aryl group having up to 20 carbon atoms and optionally having 1 to 6 substituents, wherein preferable substituents include an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkylamido group or arylamido group having 1 to 12 carbon atoms, a carbonyl group, a carboxyl group, a cyano group, a sulfonyl group, a thioalkyl group having 1 to 12 carbon atoms, and a thioaryl group having 1 to 12 carbon atoms. Z21− represents a monovalent anion. Specific examples thereof include a halogen ion, a perchlorate ion, a hexafluorophosphate ion, a tetrafluoroborate ion, a sulfonate ion, a sulfinate ion, a thiosulfonate ion, and a sulfate ion. Among these, preferred are the perchlorate ion, hexafluorophosphate ion, tetrafluoroborate ion, sulfonate ion, sulfinate ion and carbonate ion in the aspects of stability and reactivity.

In Formula (RI-III), R31, R32 and R33 each independently represent an aryl group, alkyl group, alkenyl group or alkynyl group having up to 20 carbon atoms and optionally having 1 to 6 substituents. Among these, preferred is the aryl group in the aspects of reactivity and stability. Examples of the substituents include an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkylamido group or arylamido group having 1 to 12 carbon atoms, a carbonyl group, a carboxyl group, a cyano group, a sulfonyl group, a thioalkyl group having 1 to 12 carbon atoms, and a thioaryl group having 1 to 12 carbon atoms. Z31− represents a monovalent anion. Specific examples thereof include a halogen ion, a perchlorate ion, a hexafluorophosphate ion, a tetrafluoroborate ion, a sulfonate ion, a sulfinate ion, a thiosulfonate ion, a sulfate ion, and carbonate ion. Among these, preferred are the perchlorate ion, hexafluorophosphate ion, tetrafluoroborate ion, sulfonate ion, sulfinate ion and carbonate ion, in the aspects of stability and reactivity. More preferred is the carbonate ion as described in Japanese Patent Application Laid-Open No. 2001-343742, and particularly preferred is the carbonate ion as described in Japanese Patent Application Laid-Open No. 2002-148790.

Specific examples of the suitable onium salt compounds are shown below, but the onium salt compounds should not be construed as being limited to the following examples.

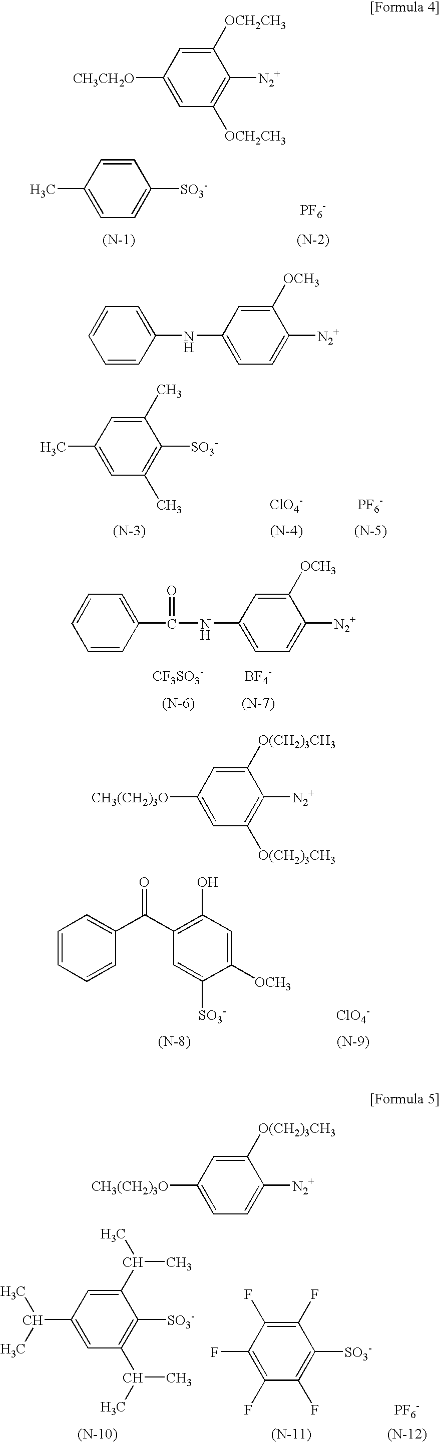

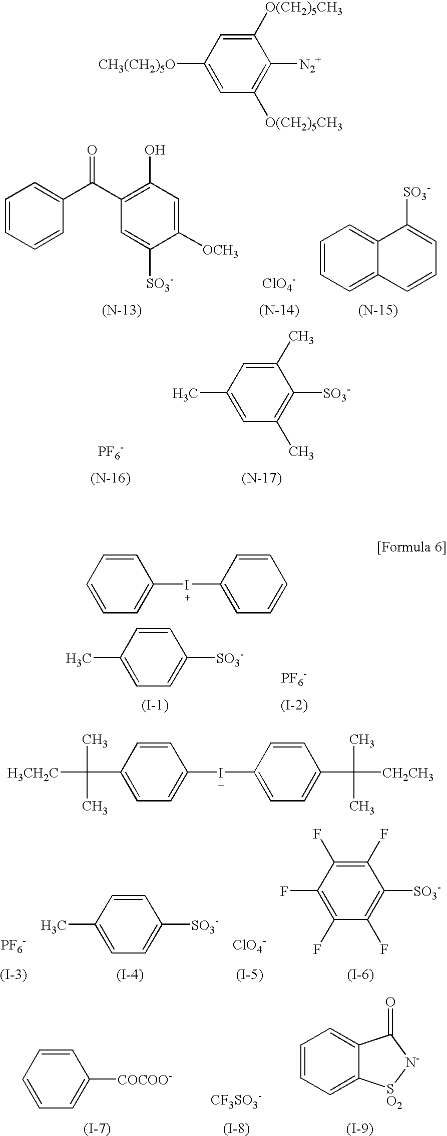

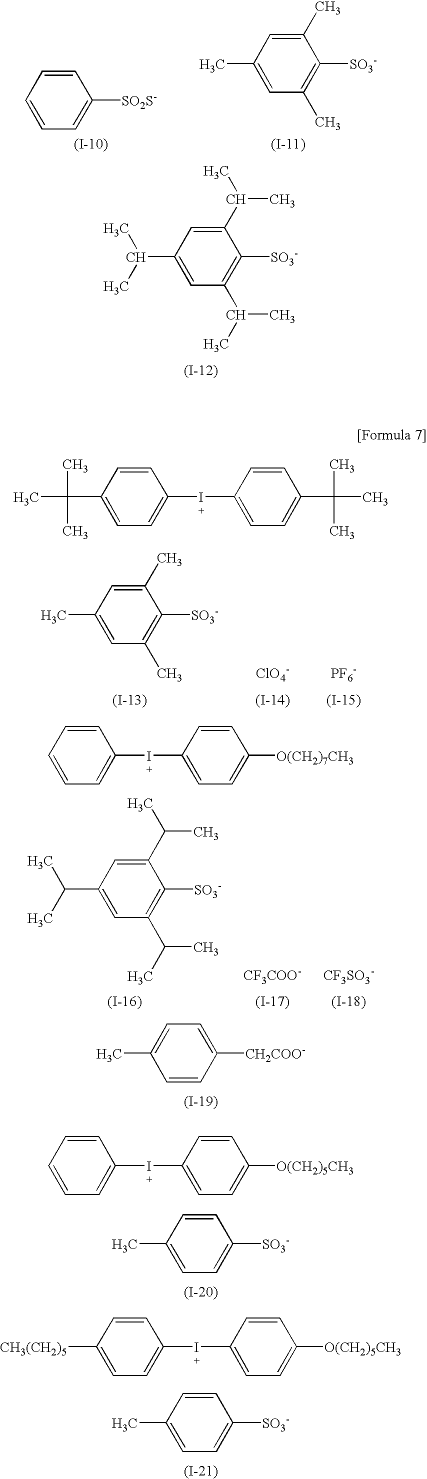

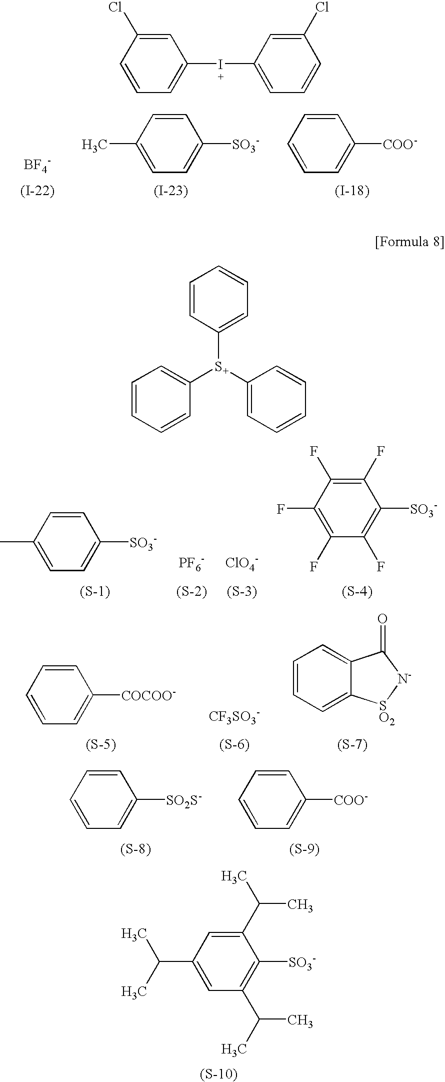

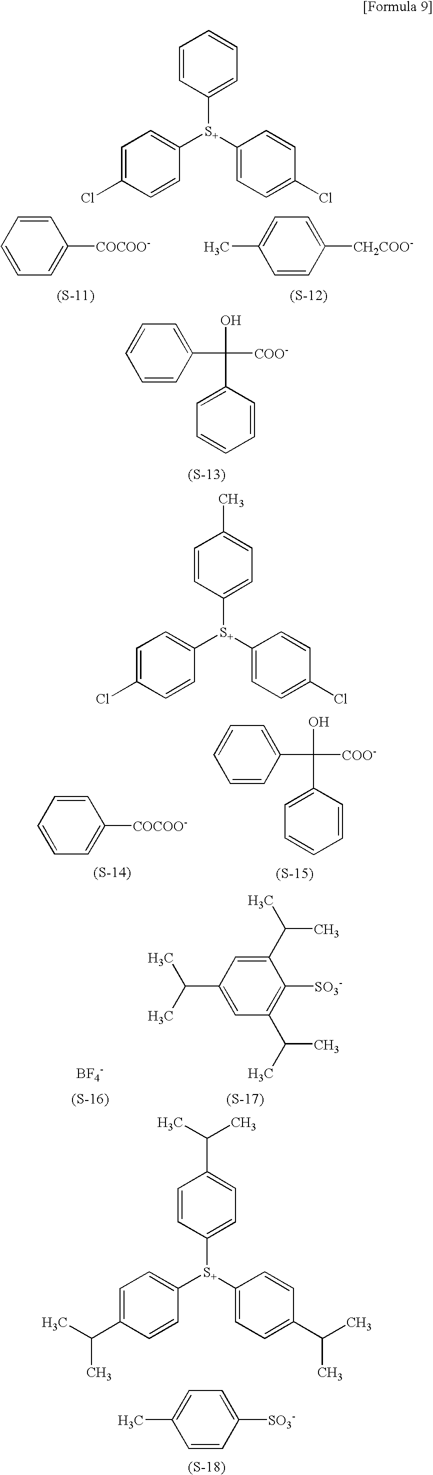

When the lithographic printing plate including the photosensitive layer for on-press development having the above ingredients [(a) actinic ray absorber, (b) polymerization initiator and (c) polymerizable compound] was protected or packaged using the protecting/packaging material such as the conventional inter leaf, protective pasteboard and packaging material, the toning was exhibited in the lithographic printing plate. On the other hand, even if the lithographic printing plate was similarly protected or packaged by the protecting/packaging material of the present invention in which the chlorine concentration of the protecting/packaging material was set to 1.5% by weight or less, the toning was not exhibited.

This suggests that chlorine contained in the protecting/packaging material may decompose the polymerization initiator as the ingredient of the photosensitive layer, resulting in the toning.

Next, an example of a method for packaging the stacked bundle of the lithographic printing plate using the protecting/packaging material of the present invention will be described.

### (Method for Packaging Lithographic Printing Plate)

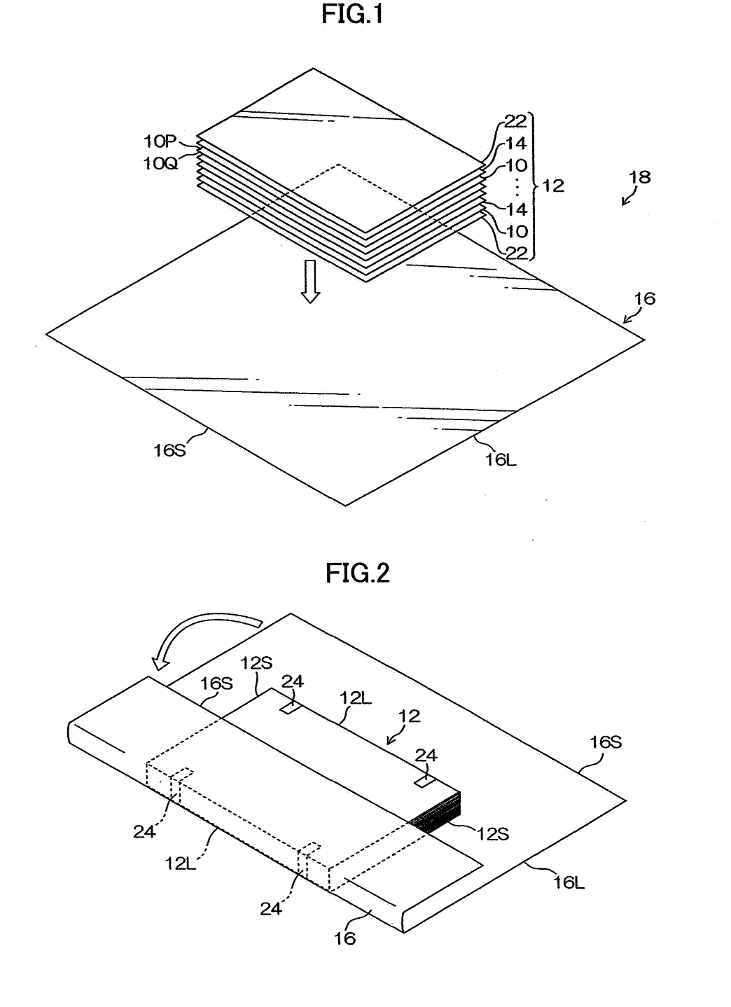

A lithographic printing plate 10 is formed by applying a photosensitive layer on a thin aluminum support formed in a rectangle plate form. This photosensitive layer is subjected to platemaking processes such as exposure, a developing process and gum coating. The lithographic printing plate 10 is set in a printing machine, and ink is then applied thereto to print characters and images or the like on a paper space thereof. Herein, a surface on which the photosensitive layer is formed is referred to as an image forming surface 10P, and a surface on which the photosensitive layer is not formed is referred to as a nonimage forming surface 10Q. Examples of the lithographic printing plates 10 include a so-called double-side product of which both surfaces are the image forming surface 10P. However, in FIG. 1, a so-called one-side product of which only one-side is the image forming surface 10P is shown.

As shown in FIG. 1, a stacked bundle 12 of the lithographic printing plate 10 is constituted by alternately stacking inter leafs 14 for protecting the photosensitive layer and the lithographic printing plates 10 in a thickness direction, and further disposing protective pasteboards 22 on the upper surface and lower surface of the stacked bundle 12. Herein, the inter leaf 14 and protective pasteboard 22 of the present invention having a chlorine concentration of 1.5% by weight or less, preferably 0.47% by weight or less are respectively used.

The number of the lithographic printing plates 10 constituting one stacked bundle 12 is not particularly limited. However, for example, 10 to 100 sheets of the lithographic printing plates 10 can be used in view of the efficiencies of conveyance and storage. Also, when 10 to 100 sheets of the lithographic printing plates 10 constitute the stacked bundle 12, the lithographic printing plates 10 and the protective pasteboards 22 are preferably fixed by a fixing device such as an adhesive tape so as to prevent a deviation between the lithographic printing plate 10 and the protective pasteboard 22. Also, the stacked bundle 12 can be constituted by much more lithographic printing plates 10 to more efficiently convey and store the stacked bundle 12 (by number of few handling). For example, the number of sheets of the lithographic printing plates 10 may be set to about 6,500 sheets at the maximum, and the protective pasteboards 22 may be inserted per 20 to 100 sheets of the lithographic printing plates 10. Furthermore, the number of sheets of the lithographic printing plates 10 may be set to about 6,500 sheets at the maximum, and the protective pasteboards 22 may be provided on only the upper and lower sides. In addition, the protective pasteboard 22 may be omitted depending upon the kind of the lithographic printing plate 10.

As shown in FIGS. 2 to 4, the stacked bundle 12 thus constituted is packaged by a package paper 16. The package paper 16 is constituted by a rectangular unbleached kraft paper formed in a predetermined size as an example. Herein, the package paper 16 of the present invention having a chlorine concentration of 1.5% by weight or less, preferably 0.47% by weight or less is used.

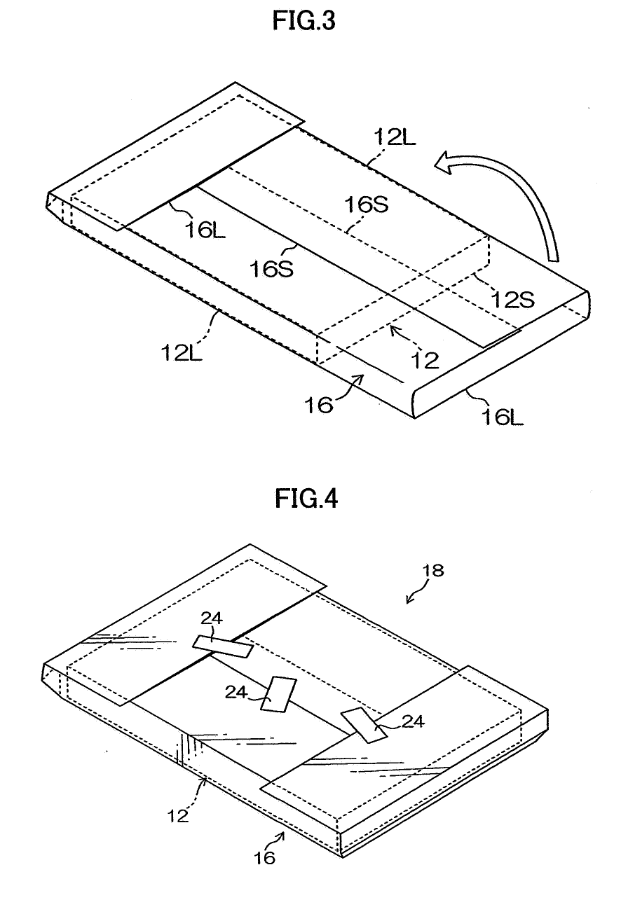

As shown in FIG. 2, the stacked bundle 12 is roughly placed in the center of the package paper 16 so that the long side 12L of the stacked bundle 12 is parallel with the short side 16S of the package paper 16. The length of the long side 16L of the package paper 16 is set to a predetermined length so that the vicinities of the short sides 16S of the package paper 16 overlap partially on each other with the package paper 16 folded from both the sides along the long side 12L of the stacked bundle 12 (see FIG. 3).

The length of the short side 16S of the package paper 16 is set to a predetermined length so as to partially overlap the upper surface of the stacked bundle 12 in plan view when the long side 16L of the package paper 16 is further folded from a state where the vicinities of the short sides 16S overlap partially on each other (see FIG. 3). Thus, the stacked bundle 12 is packaged by the package paper 16, whereby, as shown in FIG. 4, the whole surface of the stacked bundle 12 is covered with the package paper 16.

Finally, the package paper 16 is stuck at a prescribed position by an adhesive tape 24 to fix the package paper 16 so as to prevent the package paper 16 from carelessly being spread or dropped.

FIG. 4 shows an example of a structure where the stacked bundle 12 is packaged by the package paper 16, and needless to say, the present invention is not limited thereto. After all, the lithographic printing plate 10 needs only to be surely protected from light and moisture by covering the stacked bundle 12 with the package paper 16 (in some cases, by the combination with an exterior material 18 to be described later).

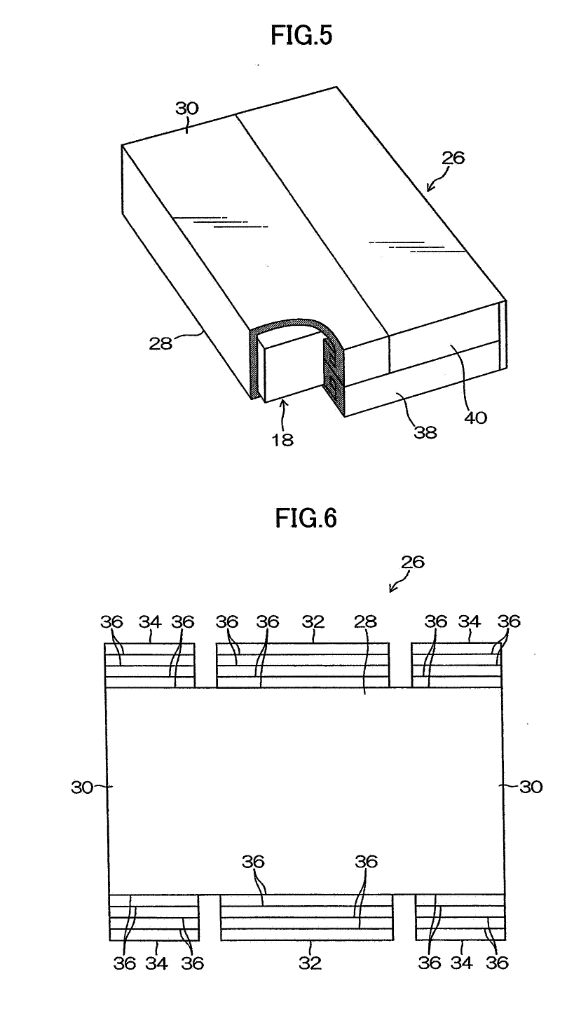

The stacked bundle 12 packaged by the package paper 16 can be also further packaged by the exterior material depending upon the kind of the lithographic printing plate 10. FIG. 5 shows the lithographic printing plate packaged by a packaging box 26 made of cardboard as an example of the exterior material.

As is apparent from the development view shown in FIG. 6, in this packaging box 26, a bottom surface laminate plate 32 and an upper surface laminate plate 34 are adjacently disposed at the short side of a bottom surface plate 28 and the short side of an upper surface plate 30. A plurality of folding lines 36 are formed on the bottom surface laminate plate 32 and the upper surface laminate plate 34. As shown in FIG. 5, spiral laminate parts 38 and 40 are constituted by folding the plates 32, 34 at the folding lines 36. Thereby, a packaging body prepared by packaging the stacked bundle 12 with the package paper 16 is protected by the packaging box 26. Even when, for example, a large force is acted on the packaging body from the outside, the lithographic printing plate 10 is prevented from being transformed or damaged.

The stacked bundle 12 may be further loaded on a palette and a loading member particularly prepared according to the kind and conveyance method or the like of the lithographic printing plate 10, and the palette and the loading member will be described later.

Herein, various kinds of the inter leafs 14, protective pasteboards 22, package papers 16 and packaging boxes 26 according to the present invention, which contain the palette and the other loading member when they are further used, have a predetermined shape, structure and physical properties or the like respectively determined according to the kind, shape and characteristics or the like of the lithographic printing plate 10. The characteristics of the lithographic printing plate 10 can be maintained in a fixed range to surely hold the quality by independently using them or by combining them with the other packaging material for the lithographic printing plate to package the lithographic printing plate 10.

The lithographic printing plate 10 may be set to an automatic platemaking machine having an automatic plate feeding function and a so-called plate setter or the like in a state where the stacked bundle 12 is constituted, and may be supplied (plate-fed) to a platemaking process. In this case, the inter leaf 14 and the protective pasteboard 22 should be peeled off from the lithographic printing plate 10 to plate-feed the inter leaf 14 and the protective pasteboard 22. Therefore, the use of the automatic platemaking machine and plate setter or the like having the automatic plate feeding function for automatically peeling off the inter leaf 14 and supplying the lithographic printing plate 10 can attain the efficiency of platemaking work.

However, when the inter leaf 14 and the protective pasteboard 22 are strongly stuck to the lithographic printing plate 10, the inter leaf 14 and the protective pasteboard 22 are supplied without peeling off the inter leaf 14 and the protective pasteboard 22 from the lithographic printing plate. Accordingly, disadvantages such as the stopping of the automatic plate feeding operation may be generated.

When, for example, the inter leaf 14 is adsorbed and held up by a sucker or the like with the inter leaf 14 brought into contact with the image forming surface 10P of the lithographic printing plate 10, the inter leaf 14 and the lithographic printing plate 10 may be integrally held up and supplied. Also, even when the nonimage forming surface 10Q of the lithographic printing plate 10 is adsorbed and held up, the lithographic printing plate 10 may be supplied with the inter leaf 14 stuck to the image forming surface OP. Furthermore, when the image forming surface 10P of the lithographic printing plate 10 or the nonimage forming surface 10Q which is not brought into contact with the inter leaf 14 is adsorbed and held up from the stacked bundle 12, the inter leaf 14 and the lithographic printing plate 10 may be held up and supplied with the inter leaf 14 and the lithographic printing plate 10 stuck at the bottom.

Also, the sure protection of the photosensitive layer (image forming surface) of the lithographic printing plate 10 is required as the original function of the inter leaf 14. Even when, particularly, the inter leaf 14 and the image forming surface rub with each other, so-called film peeling (phenomenon where the photosensitive layer is peeled off) needs to be surely prevented.

In order to satisfy the condition, the inter leaf 14 has a contact part which is brought into contact with the photosensitive layer of the lithographic printing plate 10 and has Beck's smoothness (defined in JIS P8119) of 3 seconds to 900 seconds (inclusive), more preferably 8 seconds to 560 seconds (inclusive).

As the inter leaf 14, for example, paper containing wood pulp of 100%, paper containing synthetic pulp without containing the wood pulp of 100%, and paper prepared by providing a low density polyethylene layer on the surface of each of the papers or the like can be used. Since, particularly, the paper containing no synthetic pulp reduces the material cost, the inter leaf 14 can be produced at low cost. More specific examples include a inter leaf which is paper made from bleaching kraft pulp and has a basis weight of 30 to 60 g/m², a density of 0.7 to 0.85 g/cm³, a moisture of 4.0 to 8.0% and pH of 4 to 6. However, of course, the inter leaf is not limited thereto.

Also, the protective pasteboard 22 has a contact part which is brought into contact with the photosensitive layer of the lithographic printing plate 10 and has Beck's smoothness (defined in JIS P8119) of 3 seconds to 900 seconds (inclusive), more preferably 8 seconds to 560 seconds (inclusive).

As the material of the protective pasteboard 22, for example, wood pulp, natural fibers such as hemp, synthetic pulp which is obtained from linear polymers such as polyolefin, and regenerated cellulose or the like can be used alone or combination thereof. Particularly, the protective pasteboard 22 can be produced at low cost by selecting low cost materials such as the wood pulp and the natural fibers. More specific examples include the protective pasteboard 22 prepared by papermaking using a paper material prepared by finely grinding used paper, adding a sizing agent of 0.1% based on the pasteboard weight and a paper-strengthening agent of 0.2% based on the pasteboard weight into a paper material diluted to a concentration of 4%, and further adding aluminum sulfate until pH is set to 5.0. The protective pasteboard 22 has a density 0.72 g/cm³ and a basis weight 640 g/m². However, the protective pasteboard 22 is not limited thereto.

Also, even in the package paper 16, preferably, Beck's smoothness of at least a part which is brought into contact with the image forming surface of the lithographic printing plate 10, i.e., the contact part satisfy the above condition.

When the package paper 16 satisfies this condition, the other condition is not particularly limited. Thereby, for example, the package paper 16 can be produced at low cost by selecting the material of low cost.

Also, recently, there has been a sensitive type (hereinafter, “laser exposure type”) lithographic printing plate 10 drawing using laser. When the stacked bundle 12 is constituted using the above protective pasteboard 22 in the laser exposure type lithographic printing plate 10, the moisture contained in the protective pasteboard 22 may deteriorate the photosensitive layer depending upon the characteristics of the photosensitive layer. Thereby, the protective pasteboard 22 having a moisture-proof layer may be used if needed. The moisture-proof layer having a structure prepared by sticking a layer made of low density polyethylene (LDPE) to the protective pasteboard generally used is often used. Therefore, when the layer made of low density polyethylene (LDPE) is stuck on the surface of the protective pasteboard 22, the chlorine concentration contained in the layer made of low density polyethylene (LDPE) needs to be 1.5% by weight or less.

### EXAMPLES

The following test was performed by using the lithographic printing plate for on-press development described in the above embodiment. The lithographic printing plate comprises the support (aluminum plate), the image-recording layer which contains (a) the actinic ray absorber, (b) the polymerization initiator and (c) the polymerizable compound and can be removed by the printing ink, the fountain solution or both the printing ink and the fountain solution, and the overcoat layer containing the inorganic layer compound in this order.

As shown in FIG. 1, six kinds of inter leafs 14 (A paper, B paper, C paper-1, C paper-2, D paper-1, D paper-2) shown in Table 1 were inserted between lithographic printing plates 10 of the stacked bundle 12 to produce six samples of stacked bundles having different inter leafs 14. Next, the six samples of the stacked bundles were respectively packaged by aluminum kraft paper as package paper having a chlorine concentration of 2 wt % or less to produce samples of six packaging bodies (see FIG. 4). The samples of the packaging bodies were left for three days under an environment of 60° C. Then, the printing was performed using the lithographic printing plate 10 of each of the samples of the packaging bodies to confirm the existence of the toning caused by the protecting/packaging material such as the inter leaf 14 or package paper 16. The protective pasteboard 22 was not used in this example.

TABLE 1

| | | Moisture | | | Element concentration (wt %)* | | | | | | | | |
|---|---|---|---|---|---|---|---|---|---|---|---|---|---|
| | Weight g/m² | content wt % | pH | Conductivity | C | Na | Mg | Al | Si | S | Cl | Ca | Others |
| A paper | 41.0 | 6.6 | 4.58 | 5.85 | 98.71 | — | 0.18 | 0.54 | 0.20 | 0.08 | 0.17 | 0.11 | 0.01 |
| B paper | 30.8 | 7.1 | 4.90 | 5.88 | 98.51 | 0.10 | 0.10 | 0.54 | 0.15 | 0.06 | 0.47 | 0.07 | — |
| C paper-1 | 53.4 | 7.6 | 4.45 | 19.55 | 96.09 | 0.12 | 0.06 | 1.09 | 0.25 | 0.21 | 2.02 | 0.16 | — |
| C paper-2 | 53.7 | 7.2 | 4.32 | 18.88 | 96.40 | 0.17 | 0.07 | 0.87 | 0.14 | 0.23 | 1.92 | 0.16 | 0.04 |
| D paper-1 | 42.0 | 7.2 | 4.70 | 10.85 | 97.64 | 0.11 | 0.31 | 0.03 | 0.10 | 0.22 | 1.50 | 0.05 | 0.04 |
| D paper-2 | 43.0 | 7.0 | 4.60 | 12.02 | 96.67 | 0.11 | 0.31 | 1.00 | 0.10 | 0.22 | 1.50 | 0.05 | 0.04 |

*Elements having a content of 0.01 wt % or more were shown.
Symbol “—” shows non-detection.

As a result, the lithographic printing plate 10 prepared by respectively inserting four kinds of the inter leafs 14 of the A paper, B paper, D paper-1 and D paper-2 and protecting and packaging using the package paper 16 having a chlorine concentration of 2 wt % or less had no generated toning, and made the quality get a passing grade. Particularly, the A paper and B paper having a chlorine concentration of 0.47% by weight or less showed satisfactory results.

On the other hand, the C paper-1 and the C paper-2 exhibited the toning notably, and made the quality of the lithographic printing plate 10 get a failing grade.

The present inventor investigated which element is related to the toning from the element concentrations in Table 1 of four kinds of the passing A paper, B paper, D paper-1 and D paper-2 and the element concentrations in table 1 of two kinds of the failing C paper-1 and C paper-2.

As shown in Table 1, the present inventor can consider that the concentrations of carbon (C), sodium (Na), silicon (Si), calcium (Ca) and the other elements are substantially same in the A paper, the B paper, the D paper-1, the D paper-2, the C paper-1 and the C paper-2. The concentrations of magnesium (Mg), aluminum (Al), sulfur (S) and chlorine (Cl) are different.

Then, referring to the element having a different concentration, the passing A paper, D paper-1 and D paper-2 contain more magnesium (Mg), and conversely, the failing C paper-1 and C paper-2 contain less magnesium (Mg). Thereby, the present inventor investigates that magnesium (Mg) is not the element having a negative influence on the toning.

Although the failing C paper-1 and C paper-2 contain more aluminum (Al), the passing D paper-2 also contains aluminum (Al) of the same range. Thereby, the present inventor investigates that aluminum (Al) is not the element having a negative influence on the toning.

Although the failing C paper-1 and C paper-2 contain more sulfur (S), the passing D paper-1 and D paper-2 contain sulfur (S) of the same range. Thereby, the present inventor investigates that sulfur (S) is not the element having a negative influence on the toning.

Finally, the passing A paper, B paper, D paper-1 and D paper-2 contain few chlorine (Cl), and the failing C paper-1 and C paper-2 contain more chlorine (Cl).

From the description, the present inventor investigates that only chlorine has a correspondence relation with the toning and the chlorine concentration contained in the protecting/packaging material has a large effect on the toning of the lithographic printing plate in protecting and packaging the lithographic printing plate 10 by the protecting/packaging material. The present inventor presumes that the polymerization initiator contained in the photosensitive layer of the lithographic printing plate is decomposed by chlorine when the chlorine concentration contained in the protecting/packaging material exceeds 1.5% by weight, thereby exhibiting the toning.

Originally, referring to each of the element concentrations shown in Table 1, it is an ideal to change one element concentration, and produce a plurality of protecting/packaging materials having fixed concentrations of remaining elements to examine which element is related to the toning. However, since the examination cannot be actually performed, the present inventor investigates that the chlorine concentration has an effect on the toning by the elimination method described above.

What is claimed is:

1. A protecting/packaging material for protecting and/or packaging a lithographic printing plate, which serves in contact with a photosensitive layer of the lithographic printing plate, wherein
the protecting/packaging material has a chlorine concentration of 1.5% by weight or less.

2. The protecting/packaging material for protecting and/or packaging a lithographic printing plate according to claim 1, wherein
the protecting/packaging material has a chlorine concentration of 0.47% by weight or less.

3. The protecting/packaging material for protecting and/or packaging a lithographic printing plate according to claim 1, wherein
the protecting/packaging material is a inter leaf inserted between the lithographic printing plates when the lithographic printing plates are stacked.

4. The protecting/packaging material for protecting and/or packaging a lithographic printing plate according to claim 1, wherein
the protecting/packaging material is package paper for packaging the lithographic printing plate or a stacked bundle of the lithographic printing plates.

5. The protecting/packaging material for protecting and/or packaging a lithographic printing plate according to claim 1, wherein
the protecting/packaging material is a protective pasteboard applied to the upper and lower surfaces of the lithographic printing plate or stacked bundle of the lithographic printing plates when the protecting/packaging material packages the lithographic printing plate(s).

6. The protecting/packaging material for protecting and/or packaging a lithographic printing plate according to claim 1, wherein
the lithographic printing plate includes a photosensitive layer for on-press development.

7. A packaging method for packaging a lithographic printing plate, comprising
the step of packaging the lithographic printing plate using a packaging material having a chlorine concentration of 1.5% by weight or less.

8. The packaging method for packaging a lithographic printing plate according to claim 7, further comprising, prior to packaging the lithographic printing plate using the packaging material, at least one of the steps of:
stacking a plurality of lithographic printing plates to produce a stacked bundle and inserting a inter leaf having a chlorine concentration of 1.5% by weight or less between the stacked lithographic printing plates; and
applying a protective pasteboard having a chlorine concentration of 1.5% by weight or less to the upper surface and/or lower surface of the stacked bundle.

9. A lithographic printing plate or a stack thereof, which is protected and/or packaged by the protecting/packaging material of claim 1.
